(19) United States
(12) Patent Application Publication
(10) Pub. No.: US 2006/0093849 A1
(43) Pub. Date: May 4, 2006

(54) Method for applying chromium-containing coating to metal substrate and coated article thereof

(76) Inventors: Andrew David Farmer, West Chester, OH (US); Bangalore Aswatha Nagaraj, West Chester, OH (US); Roger Dale Wustman, Mason, OH (US); Theodore Robert Grossman, Hamilton, OH (US); John Frederick Reiss, Long Beach, CA (US)

Correspondence Address: JAGTIANI + GUTTAG, 10363-A DEMOCRACY LANE, FAIRFAX, VA, 22030, US

(21) Appl. No.: 10/978,427

(22) Filed: Nov. 2, 2004

(51) Int. Cl. B05D 3/02

(52) U.S. Cl. 428/651; 428/666; 428/670; 416/214 R; 427/372.2

(57) ABSTRACT

A method for applying a chromium containing coating to an underlying metal substrate where the metal substrate has an overlaying platinum-containing layer, as well as a corrosion resistant coated article thereof. A chromium-containing layer is deposited on the platinum-containing layer with an aluminide diffusion layer being deposited on the chromium-containing layer, the aluminide diffusion layer having an inner diffusion layer adjacent the chromium-containing layer and an outer additive layer adjacent to the inner diffusion layer. The chromium-containing layer is deposited by a deposition technique that permits chromium in the chromium-containing layer to more readily diffuse into a subsequently deposited aluminde diffusion coating layer. The chromium-containing and aluminide diffusion layers are then treated to cause chromium from the chromium-containing layer to diffuse into the outer additive layer in an amount of at least about 8%. The resulting coated article is resistant to corrosion.

### BACKGROUND OF THE INVENTION

This invention relates to a method for applying a chromium-containing coating to a metal substrate of an article, such as a turbine airfoil, to provide corrosion protection for the surface of the substrate. This invention further relates to a corrosion resistant article that has such a coating.

Higher operating temperatures of gas turbine engines are continuously sought in order to increase their efficiency. Significant advances in high temperature capabilities have been achieved through formulation of nickel and cobalt-base superalloys, though such alloys alone are often inadequate to form components located in certain sections of a gas turbine engine, such as turbine rotors, blades and vanes, turbine shrouds, buckets, nozzles, combustion liners and deflector plates, augmentors and the like. However, as operating temperatures increase, the high temperature durability of the components of the engine must correspondingly increase, including resistance to the corrosive environments that surround and permeate these turbine components.

Turbine engine components, such as airfoils used in turbine blades and vanes, are typically heated to temperatures in excess of 1500° F. (815° C.) during service and exposed to highly corrosive exhaust gases from the gas turbine. At such temperatures, oxygen and other corrosive components of the exhaust gas can cause undesired corrosion of the metal substrate of the turbine airfoil, even metal substrates that comprise nickel and cobalt-base superalloys. In addition, cooling of turbine airfoils is typically necessary to remove excessive heat. For example, the turbine airfoil can be provided with internal cooling passages with air being forced through these cooling passages and out openings at the external surface of the airfoil, thus removing heat from the interior of the airfoil and, in some cases, providing a boundary layer of cooler air at the surface of the airfoil. See, for example, commonly assigned U.S. Pat. No. 6,183,811 B1 (Conner), issued Feb. 6, 2001; and U.S. Pat. No. 5,928,725 (Howard et al), issued Jul. 27, 1999.

Many protective coatings have been developed for metal substrates to improve the life of turbine airfoils. These protective coatings are typically 2 to 5 mils (51 to 127 microns) in thickness and provide protection to the metal substrate from oxidation and corrosion at higher temperatures that the airfoil is subjected to during operation. These include oxidation-resistant aluminide diffusion coatings such as, for example, nickel aluminide and platinum aluminide coatings. These aluminide diffusion coatings can be applied to the metal substrate by pack cementation techniques, or more recently by chemical vapor phase deposition (CVD) techniques. See, for example, U.S. Pat. No. 4,148,275 (Benden et al), issued Apr. 10, 1979; commonly assigned U.S. Pat. No. 5,368,888 (Rigney), issued Nov. 29, 1994, U.S. Pat. No. 5,928,725 (Howard et al), issued Jul. 27, 1999; U.S. Pat. No. 6,039,810 (Mantkowski et al), issued Mar. 21, 2000, U.S. Pat. No. 6,183,811 B1 (Conner), issued Feb. 6, 2001; and U.S. Pat. No. 6,224,941 B1 (Chen et al), issued May 1, 2001, which disclose various apparatus and methods for applying aluminide diffusion coatings.

For additional protection against corrosion at lower temperatures, or in marine environments where corrosive salts can be present, it can be desirable to include chromium in the protective coating. Chromium can be applied to the metal substrate surface by spraying a chromium-containing powder onto the surface thereof. However, for turbine airfoils having internal air cooling passages, the heterogeneity and especially surface roughness of such spray coatings on the external surface of the airfoil can be undesirable. Chromium can also be applied by depositing the chromium on the metal substrate, and then interdiffusing the chromium with the metal alloy in the substrate. See commonly assigned U.S. Pat. No. 6,283,715 (Nagaraj et al), issued Sep. 4, 2001. This is typically followed by applying an aluminide diffusion coating by pack cementation or CVD techniques to the deposited chromium-containing layer.

This aluminide diffusion coating applied to the deposited chromium-containing layer typically forms an inner diffusion layer adjacent to the chromium-containing layer, and an outer additive layer adjacent to the diffusion layer. It has been found that insufficient chromium is delivered to this outer additive layer during subsequent diffusion processes that occur to provide beneficial corrosion protection. In particular, the level of chromium delivered to this outer additive layer is about 6% by weight or less of this outer layer.

Accordingly, it would be desirable to be able to incorporate chromium as a component of a coating for a metal substrate that also includes an aluminide diffusion coating in a manner that provides beneficial corrosion protection to the metal substrate. It would also be desirable to be able to incorporate this chromium into the protective coating of a metal substrate that is used with a turbine airfoil or other component that has internal cooling air passages or similar passages. It would be further desirable to be able to incorporate this chromium using a process that is compatible with various metal substrates, as well as other materials, that the turbine airfoil is made of and that provides a relatively inexpensive protective coating.

### BRIEF DESCRIPTION OF THE INVENTION

An embodiment of this invention relates to a method for applying a corrosion resistant chromium-containing coating to an underlying metal substrate where the metal substrate has an overlaying platinum-containing layer. This method comprises the steps of:
(1) depositing a chromium-containing layer on the platinum-containing layer by a deposition technique that permits chromium in the chromium-containing layer to more readily diffuse into a subsequently deposited aluminde diffusion coating layer;
(2) depositing on the chromium-containing layer an aluminide diffusion layer having an inner diffusion layer adjacent to the chromium-containing layer and an outer additive layer adjacent to the inner diffusion layer; and
(3) treating the chromium-containing and aluminide diffusion layers to cause chromium from the chromium-containing layer to diffuse into the outer additive layer in an amount of at least about 8%.

Another embodiment of this invention relates to a corrosion resistant coated article. This article comprises:
a. a metal substrate;
b. a platinum-containing layer adjacent to and overlaying the substrate;
c. a chromium-containing layer adjacent to and overlaying the platinum-containing layer, and
d. an aluminide diffusion layer comprising an inner diffusion layer overlaying and adjacent to the chromium-containing layer and an outer additive layer adjacent to the inner diffusion layer, the outer additive layer comprising at least about 8% by weight diffused chromium.

The method of this invention, well as the resulting corrosion resistant coated article, provides several benefits. This method allows effective incorporation of chromium as a component of the corrosion resistant protective coating, in particular the aluminide diffusion layer of the coating, that provides effective corrosion resistance and protection for the underlying metal substrate. In particular, sufficient chromium (i.e., at least about 10%) can diffuse into the outer additive layer of the aluminide diffusion layer of the coating. This method provides a chromium-containing coating that is compatible with various metal substrates and other materials that turbine airfoils comprise. This method can also be used to incorporate desired, beneficial chromium into the protective coating for an underlying metal substrate that is used with a turbine airfoil (e.g., turbine blade) or other component that has internal cooling air passages or similar passages without causing other undesired effects such as closure of such internal cooling passages, or increasing surface roughness and damage due to excessive heat treatments. This method also allows for the repair of components, especially turbine airfoils, that previously have had no protective coating thereon.

### BRIEF DESCRIPTION OF THE DRAWINGS

FIG. 1 is a perspective view of a turbine blade for which the protective coating of this invention is useful.

FIG. 2 is an enlarged sectional view through the airfoil portion of the turbine blade of FIG. 1, taken along line 2-2, showing an embodiment of the protective coating of this invention.

FIG. 3 is block flow diagram of an embodiment of the method of this invention for applying a protective coating to a turbine blade.

### DETAILED DESCRIPTION OF THE INVENTION

As used herein, the term “comprising” means various compositions, compounds, components, layers, steps and the like can be conjointly employed in the present invention. Accordingly, the term “comprising” encompasses the more restrictive terms “consisting essentially of” and “consisting of.”

All amounts, parts, ratios and percentages used herein are by weight unless otherwise specified.

The embodiments of the method of this invention are useful in applying chromium-containing corrosion resistant protective coatings to metal substrates comprising a variety of metals and metal alloys, including superalloys, used in a wide variety of turbine engine (e.g., gas turbine engine) parts and components operated at, or exposed to, high temperatures, especially higher temperatures that occur during normal engine operation. These turbine engine parts and components can include turbine airfoils such as blades and vanes, turbine shrouds, turbine nozzles, combustor components such as liners, deflectors and their respective dome assemblies, augmentor hardware of gas turbine engines and the like. The embodiments of the method of this invention are particularly useful in applying chromium-containing corrosion resistant protective coatings to turbine blades and vanes, and especially the shank and airfoil portions of such blades and vanes. However, while the following discussion of embodiments of the method of this invention will be with reference to turbine blades and vanes, and especially the airfoil portions thereof, that comprise these blades and vanes, it should also be understood that the method of this invention can be useful with other articles comprising metal substrates that require corrosion resistant protective coatings.

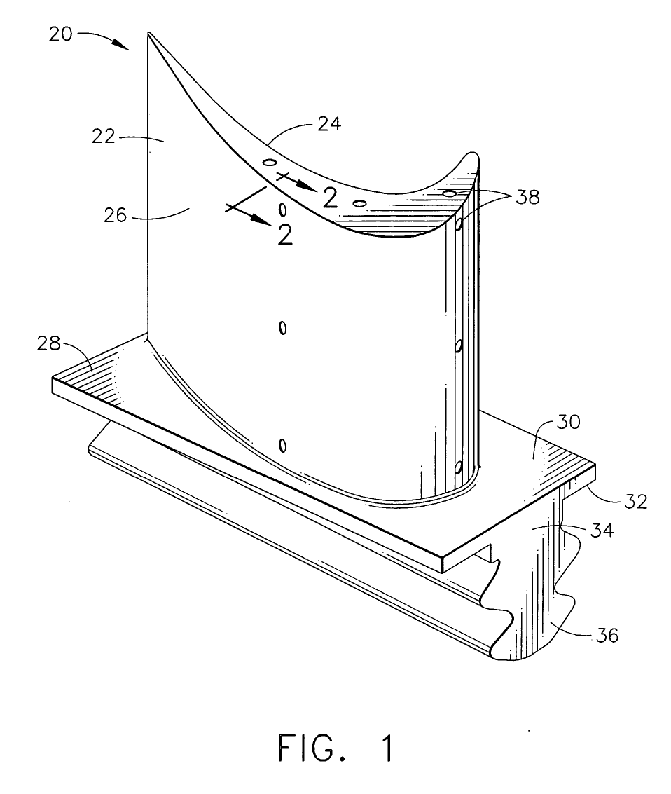

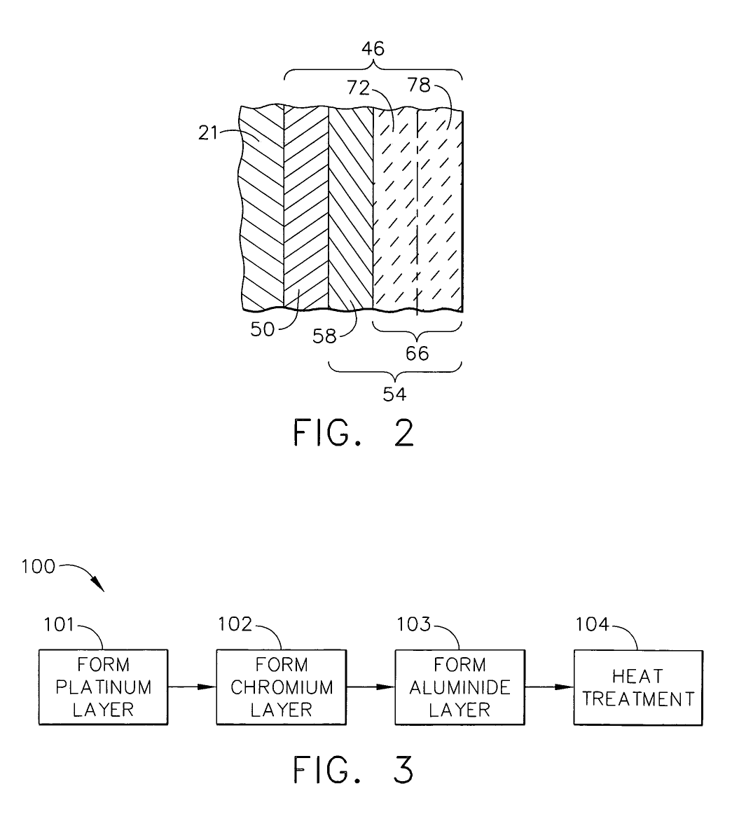

The various embodiments of the method of this invention are further illustrated by reference to the drawings as described hereafter. Referring to the drawings, FIG. 1 depicts a component article of a gas turbine engine such as a turbine blade or turbine vane, and in particular a turbine blade identified generally as 20. (Turbine vanes have a similar appearance with respect to the pertinent portions.) The turbine blade 20 is formed of any operable material, for example, a nickel-base superalloy, which is the base metal of the turbine blade 20. The base metal of the turbine blade serves as a metal substrate 21 (see FIG. 2) for the coatings that are described hereafter. Turbine blade 20 includes an airfoil 22 against which the flow of hot exhaust gas is directed. Airfoil 22 has a “high-pressure side” indicated as 24 that is concavely shaped; and a suction side indicated as 26 that is convexly shaped and is sometimes known as the “low-pressure side” or “back side.” In operation the hot combustion gas is directed against the high-pressure side 24.

Airfoil 22 extends upwardly from a platform 28, which extends laterally outwardly from the airfoil 22. Platform 28 has a top side 30 adjacent to the airfoil 22 and a bottom side 32 remote from the airfoil 22. As shown in FIG. 1, turbine blade 20 can have a shank 34 that extends downwardly (i.e., in the opposite direction to that of the airfoil 22) from the platform 28. Turbine blade 20 is mounted to a turbine disk or hub (not shown) by a dovetail 36 that extends downwardly from shank 34 and engages a slot on the turbine disk.

In some embodiments of turbine blade 20, a number of internal passages extend through the interior of airfoil 22, ending in openings indicated as 38 in the surface of airfoil 22. During operation, a flow of cooling air is directed through the internal passages to cool or reduce the temperature of airfoil 22.

Substrate 21 can comprise any of a variety of metals or metal alloys that are typically protected by aluminide diffusion coatings. For example, substrate 21 can comprise a high temperature, heat-resistant alloy, e.g., a superalloy. Such high temperature alloys are disclosed in various references, such as U.S. Pat. No. 5,399,313 (Ross et al), issued Mar. 21, 1995 and U.S. Pat. No. 4,116,723 (Gell et al), issued Sep. 26, 1978, both of which are incorporated by reference. High temperature alloys are also generally described in Kirk-Othmer's Encyclopedia of Chemical Technology, 3rd Ed., Vol. 12, pp. 417-479 (1980), and Vol. 15, pp. 787-800 (1981). Illustrative high temperature nickel-base alloys are designated by the trade names Inconel®, Nimonic®, René® (e.g., René® 80 and René® N5 alloys), and Udimet®.

Protective coatings of this invention are particularly useful with nickel-base superalloys. As used herein, “nickel-base” means that the composition has more nickel present than any other element. The nickel-base superalloys are typically of a composition that is strengthened by the precipitation of gamma-prime phase. More typically, the nickel-base alloy has a composition of from about 4 to about 20% cobalt, from about 1 to about 10% chromium, from about 5 to about 7% aluminum, from 0 to about 2% molybdenum, from about 3 to about 8% tungsten, from about 4 to about 12% tantalum, from 0 to about 2% titanium, from 0 to about 8% rhenium, from 0 to about 6% ruthenium, from 0 to about 1% niobium, from 0 to about 0.1% carbon, from 0 to about 0.01% boron, from 0 to about 0.1% yttrium, from 0 to about 1.5% hafnium, the balance being nickel and incidental impurities.

Protective coatings of this invention are particularly useful with nickel-base alloy compositions such as René N5, which has a nominal composition of about 7.5% cobalt, about 7% chromium, about 6.2% aluminum, about 6.5% tantalum, about 5% tungsten, about 1.5% molybdenum, about 3% rhenium, about 0.05% carbon, about 0.004% boron, about 0.15% hafnium, up to about 0.01% yttrium, balance nickel and incidental impurities. Other operable nickel-base superalloys include, for example, René N6, which has a nominal composition of about 12.5% cobalt, about 4.2% chromium, about 1.4% molybdenum, about 5.75% tungsten, about 5.4% rhenium, about 7.2% tantalum, about 5.75% aluminum, about 0.15% hafnium, about 0.05% carbon, about 0.004% boron, about 0.01% yttrium, balance nickel and incidental impurities; René 142, which has a nominal composition of about 6.8% chromium, about 12.0% cobalt, about 1.5% molybdenum, about 2.8% rhenium, about 1.5% hafnium, about 6.15% aluminum, about 4.9% tungsten, about 6.35% tantalum, about 150 parts per million boron. about 0.12% carbon, balance nickel and incidental impurities; CMSX-4, which has a nominal composition of about 9.60% cobalt, about 6.6% chromium, about 0.60% molybdenum, about 6.4% tungsten, about 3.0% rhenium, about 6.5% tantalum, about 5.6% aluminum, about 1.0% titanium, about 0.10% hafnium, balance nickel and incidental impurities; CMSX-10, which has a nominal composition of about 7.00% cobalt, about 2.65% chromium, about 0.60% molybdenum, about 6.40% tungsten, about 5.50% rhenium, about 7.5% tantalum, about 5.80% aluminum, about 0.80% titanium, about 0.06% hafnium, about 0.4% niobium, balance nickel and incidental impurities; PWA1480, which has a nominal composition of about 5.00% cobalt, about 10.0% chromium, about 4.00% tungsten, about 12.0% tantalum, about 5.00% aluminum, about 1.5% titanium, balance nickel and incidental impurities; PWA1484, which has a nominal composition of about 10.00% cobalt, about 5.00% chromium, about 2.00% molybdenum, about 6.00% tungsten, about 3.00% rhenium, about 8.70% tantalum, about 5.60% aluminum, about 0.10% hafnium, balance nickel and incidental impurities; and MX-4, which has a nominal composition as set forth in U.S. Pat. No. 5,482,789 of from about 0.4 to about 6.5% ruthenium, from about 4.5 to about 5.75% rhenium, from about 5.8 to about 10.7% tantalum, from about 4.25 to about 17.0% cobalt, from 0 to about 0.05% hafnium, from 0 to about 0.06% carbon, from 0 to about 0.01% boron, from 0 to about 0.02% yttrium, from about 0.9 to about 2.0% molybdenum, from about 1.25 to about 6.0% chromium, from 0 to about 1.0% niobium, from about 5.0 to about 6.6% aluminum, from 0 to about 1.0% titanium, from about 3.0 to about 7.5% tungsten, and wherein the sum of molybdenum plus chromium plus niobium is from about 2.15 to about 9.0%, and wherein the sum of aluminum plus titanium plus tungsten is from about 8.0 to about 15.1%, balance nickel and incidental impurities. The use of the present invention is not limited to turbine components made of these preferred alloys, and has broader applicability.

As shown in FIG. 2, adjacent to and overlaying substrate 21 is a protective coating indicated generally as 46. Protective coating 46 typically has a thickness of from about 1 to about 6 mils (from about 25 to about 152 microns), more typically from about 2 to about 4 mils (from about 51 to about 102 microns).

This protective coating 46 comprises a platinum-containing layer indicated generally as 50 that overlays and is directly adjacent to substrate 21. This platinum-containing layer 50 typically has a thickness of from about 0.1 to about 0.5 mils (from about 2.5 to about 13 microns), more typically from about 0.1 to about 0.2 mils (from about 2.5 to about 5 microns). The platinum-containing layer 50 typically comprises from about 99 to 100% platinum. During post-deposition heat treatment of platinum-containing layer 50 as described hereafter, elements from substrate 21 (e.g., aluminum and nickel) can diffuse into layer 50 and, to a more limited extent, platinum can diffuse from layer 50 into substrate 21.

As shown in FIG. 2, protective coating 46 further comprises a corrosion resistant portion indicated as 54 that overlays the platinum-containing layer 50. This corrosion resistant portion 54 of coating 46 typically has a thickness of from about 0.5 to about 5.9 mils (from about 13 to about 150 microns), more typically from about 2 to about 4 mils (from about 51 to about 102 microns).

Corrosion resistant portion 54 of coating 46 includes a chromium-containing layer 58 that is directly adjacent to and overlays platinum-containing layer 50. This chromium-containing layer 58 typically has a thickness of from about 0.5 to about 2 mils (from about 13 to about 51 microns), more typically from about 0.5 to about 1 mils (from about 13 to about 25 microns). These thicknesses are usually with reference to the initial deposition of the chromium-containing layer 58. During deposition of this chromium-containing layer and especially subsequent heat treatment steps as described hereafter, the boundaries of layer 58 can become less distinct.

As shown in FIG. 2, the corrosion resistant portion 54 of coating 46 further comprises an aluminide diffusion layer 66 adjacent to and overlaying chromium-containing layer 58. This aluminide coating layer 66 has a thickness of from about 1 to about 4 mils (from about 25 to about 102 microns), more typically from about 1.5 to about 3 mils (from about 38 to about 76 microns). Like chromium-containing layer 58, these thicknesses for this aluminide diffusion layer 66 are usually with reference to the initial deposition of layer 66. During deposition of this aluminide diffusion layer 66 and especially subsequent heat treatment steps as described hereafter, the boundaries of layer 66 can become less distinct.

As shown in FIG. 2, aluminide diffusion layer 66 typically comprises an inner diffusion layer 72 (typically from about 30 to about 60% of the thickness of coating layer 66, more typically from about 40 to about 50% of the thickness of coating layer 66) directly adjacent to chromium-containing layer 58 and an outer additive layer 78 (typically from about 40 to about 70% of the thickness of layer 66, more typically from about 50 to about 60% of the thickness of layer 66) directly adjacent to diffusion layer 72. Other optional coating layers, if any, such as ceramic thermal barrier coatings, can also be deposited, if desired, on aluminide diffusion layer 66.

FIG. 3 depicts a block diagram of an embodiment of the method of this invention that is indicated generally as 100 for providing protective coatings 46, and especially corrosion resistant portion 54. As shown in FIG. 3, the initial step of this method indicated as 101 involves depositing the platinum-containing layer 50 on substrate 21. The platinum-containing layer 50 can be formed on substrate 21 by any suitable method known to those skilled in the art. For example, electroplating is typically used to apply platinum-containing layer 50 to substrate 21. In electroplating, the platinum-containing layer 50 is typically deposited on substrate 21 from an aqueous solution containing a dissolved platinum salt. For example, a platinum-containing aqueous solution of Pt(NH₃)₄HPO₄ having a concentration of from about 4 to about 20 gams per liter of platinum, can be used for plating on platinum-containing layer 50 (using a voltage/current source of from about 0.5 to about 10 amps/ft²) in from about 1 to about 4 hours at a temperature from about 190° to about 200° F. (from about 88° to about 93° C.). Other techniques for applying platinum-containing layers on metal substrates, such sputtering or ion plasma techniques, can also be used instead of electroplating.

As also shown in FIG. 3, the next step of this method indicated as 102 involves depositing chromium-containing layer 58 on platinum-containing layer 50. Typically, platinum-containing layer 50 is heat treated, typically at temperature of from about 1700° to about 2000° F. (from about 927° to about 1093° C.) for from about 0.5 to about 2 hours, prior to depositing chromium-containing layer 58 thereon. The chromium-containing layer 58 can be deposited on platinum-containing layer 50 by diffusion techniques, including chemical vapor phase deposition (CVD) and pack cementation (using techniques described hereafter for depositing aluminum diffusion layer 66), by plating techniques and by overlay coating techniques such as sputtering and ion plasma. The primary characteristic of these techniques for depositing chromium-containing layer 58 is that they allow chromium from this layer to subsequently diffuse more readily into the aluminide diffusion layer during subsequent heat treatment. Any chromium containing composition suitable for such deposition techniques can be used for forming chromium-containing layer 58, including, for example, compositions comprising from about 20 to about 30% chromium, plus any optional modifying elements such as silicon. The chromium-containing layer 58 can be deposited so as to cover the entire surface of turbine blade 20, or can be deposited on only portions of turbine blade 20, for example, solely on the surface of shank 34 and/or the surface of airfoil portion 22 by, for example, masking the other portions of blade 20, for example, dovetail 36, where protective coating 46 is not needed. If chromium-containing layer 58 is deposited so as to cover the entire surface of turbine blade 20, the deposited layer 58 can be removed (e.g., by machining) from those portions of blade 20 where the protective coating 46 is not needed.

As shown in FIG. 3, the next step of this method indicated as 103 involves applying or depositing the aluminide diffusion layer 66 on chromium-containing layer 58. Any conventional method for depositing aluminide diffusion coatings can be used, such as pack cementation, above-the-pack aluminiding, slurry deposition, chemical vapor phase deposition (CVD), and organo-metallic chemical vapor deposition. See, for example, commonly assigned U.S. Pat. No. 5,368,888 (Rigney), issued Nov. 29, 1994, U.S. Pat. No. 6,039,810 (Mantkowski et al), issued Mar. 21, 2000, U.S. Pat. No. 6,183,811 B1 (Conner), issued Feb. 6, 2001; U.S. Pat. No. 6,224,941 B1 (Chen et al), issued May 1, 2001; col. 8, lines 25-61 of commonly-assigned U.S. Pat. No. 6,283,715 (Nagaraj et al), issued Sep. 4, 2001, which are all incorporated by reference. The aluminide diffusion layer 66 can optionally be modified by including alloying elements. The source of aluminum can be a gaseous source, as in vapor phase aluminiding. In this approach, a hydrogen halide gas, such as hydrogen chloride, is contacted with the aluminum metal or an aluminum alloy to form the corresponding aluminum halide gas. Aluminide-modifying elements, such as hafnium, zirconium, yttrium, silicon, titanium, tantalum, cobalt, platinum, and palladium, can optionally be doped from similar sources into the gaseous source. The source gas is contacted to those portions of turbine blade 20 which are to be covered by protective coating 46. The deposition reaction typically occurs at elevated temperature such as in the range of from about 1800° to about 2100° F. (from about 982° to about 1149° C.) for a period of typically from about 4 to about 8 hours.

As shown in FIG. 3, the resulting combination of layers 58 and 66 are treated, as indicated by step 104, to cause sufficient diffusion of chromium from layer 58 into outer additive layer 78 of coating layer 66. During treatment in step 104, at least about 8% chromium (typically in the range of from about 8 to about 25% chromium, more typically in the range of from about 10 to about 15% chromium) is diffused from chromium-containing layer 58 into the outer additive layer 78. Treatment during step 104 is typically carried out by heating of the layers 58 and 66 to elevated temperatures for a period of time adequate to permit sufficient diffusion of chromium from chromium-containing layer 58 into outer additive layer 78. Heating of layers 58 and 66 to temperatures adequate to permit sufficient chromium diffusion can occur during deposition of the aluminide diffusion layer 66 because the temperatures involved (and heat generated) during the deposition of layer 66 can be sufficiently high to cause adequate diffusion of chromium from layer 58 into outer additive layer 78. However, step 104 is typically carried out by heating the resulting protective coating after deposition of all layers (i.e., 58 and 66) is completed. Heat treatment typically involves subjecting the resulting protective coating 46 to temperatures in the range of from about 1800° to about 2100° F. (from about 982° to about 1149° C.), more typically from about 1925° to about 1975° F. (from about 1052° to about 1079° C.), for from about 1 to about 8 hours, more typically from about 2 to about 4 hours. Heat treatment is also typically carried under vacuum, or alternatively can be carried out in an inert gas atmosphere.

While the prior description of the embodiment of the method of this invention has been with reference to applying a new protective coating 46 to substrate 21 of a blade or vane 20, another embodiment of the method of this invention can also be used to repair or replace a prior existing partially or completely damaged coating 46, or at least the corrosion resistant portion 54 thereof, on substrate 21 of blade or vane 20. In the embodiment of this method, the existing partially or completely damaged coating is removed, if needed, from substrate 21, such as by grit blasting, so that a new protective coating 46, or at least the corrosion resistant portion 54 thereof, can be applied to substrate 21, as previously described and as shown in FIG. 3.

While specific embodiments of this invention have been described, it will be apparent to those skilled in the art that various modifications thereto can be made without departing from the spirit and scope of this invention as defined in the appended claims.

What is claimed is:

1. A method for applying a chromium-containing coating to an underlying metal substrate where the metal substrate has an overlaying platinum-containing layer, the method comprising the steps:
(1) depositing a chromium-containing layer on the platinum-containing layer by a deposition technique that permits chromium in the chromium-containing layer to more readily diffuse into a subsequently deposited aluminide diffusion layer;
(2) depositing on the chromium-containing layer an aluminide diffusion layer having an inner diffusion layer adjacent the chromium-containing layer and an outer additive layer adjacent the inner diffusion layer; and
(3) treating the deposited chromium-containing and aluminide diffusion layers to cause chromium from the chromium-containing layer to diffuse into the outer additive layer in an amount of at least about 8%.

2. The method of claim 1 wherein the platinum-containing layer comprises from about 99 to 100% platinum and has a thickness of from about 0.1to about 0.5 mils.

3. The method of claim 2 wherein the platinum-containing layer has a thickness of from about 0.1 to about 0.2 mils.

4. The method of claim 2 wherein the platinum-containing layer is heat treated at a temperature of from about 1700° to about 2000° F. for from about 0.5 to about 2 hours prior to deposition step (1).

5. The method of claim 1 wherein the chromium-containing layer is deposited by a diffusion coating, plating or overlay coating technique to a thickness of from about 0.5 to about 2 mils.

6. The method of claim 4 wherein the chromium-containing layer is deposited to a thickness of from about 0.5 to about 1 mils.

7. The method of claim 4 wherein the aluminide diffusion layer is deposited to a thickness of from about 1 to about 4 mils.

8. The method of claim 6 wherein the aluminide diffusion layer is deposited to a thickness of from about 1.5 to about 3 mils.

9. The method of claim 1 wherein treatment step (3) comprises heating the deposited chromium-containing and aluminide diffusion layers until the outer additive layer comprises at least about 8% chromium diffused from the chromium-containing layer.

10. The method claim 9 wherein heating of the deposited chromium-containing and aluminide diffusion layers is carried out until the outer additive layer comprises from about 8 to about 25% chromium diffused from the chromium-containing layer.

11. The method of claim 10 wherein heating of the deposited chromium-containing and aluminide diffusion layers is carried out until the outer additive layer comprises from about 10 to about 15% chromium diffused from the chromium-containing layer.

12. The method of claim 9 wherein treatment step (3) is carried out by heat generated during deposition of the aluminide diffusion layer in step (2).

13. The method of claim 9 wherein treatment step (3) is carried out by heating the deposited chromium-containing and aluminide diffusion layers after step (2) is completed to a temperature in the range of from about 1800° to about 2100° F. for from about 1 to about 8 hours.

14. The method of claim 13 wherein treatment step (3) is carried out by heating the deposited chromium-containing and aluminide diffusion layers to a temperature in the range of from about 1925° to about 1975° F. from about 2 to about 4 hours.

15. The method of claim 1 wherein the metal substrate has a prior damaged protective coating thereon and which comprises the further step of removing the damaged prior protective coating prior to step (1).

16. A corrosion resistant coated article, which comprises:
a. a metal substrate;
b. a platinum-containing layer adjacent to and overlaying the substrate;
c. a chromium-containing layer adjacent to and overlaying the platinum-containing layer, and
d. an aluminide diffusion layer comprising an inner diffusion layer overlaying and adjacent to the chromium-containing layer and an outer additive layer adjacent to the inner diffusion layer, the outer additive layer comprising at least about 8% diffused chromium.

17. The article of claim 16 wherein the chromium-containing and aluminide diffusion layers have a combined thickness of from about 0.5 to about 5.9 mils.

18. The article of claim 17 wherein the chromium-containing and aluminide diffusion layers have a combined a thickness of from about 2 to about 4 mils.

19. The article of claim 17 wherein the outer additive layer comprises from about 8 to about 25% diffused chromium.

20. The article of claim 17 wherein the outer additive layer comprises from about 1 to about 15% diffused chromium.

21. The article of claim 16 which is a turbine blade.

22. The blade of claim 21 that has internal cooling passages.
